(19) United States
(12) Patent Application Publication
(10) Pub. No.: US 2024/0004701 A1
(43) Pub. Date: Jan. 4, 2024

(54) METHODS AND APPARATUS FOR FUNCTION VIRTUAL CONFIGURATION SPACE PRESENTATION MIGRATION AND INPUT/OUTPUT TRAFFIC ROUTE MIGRATION ORDERING

(71) Applicant: GIGAIO NETWORKS, INC., Carlsbad, CA (US)

(72) Inventor: David O'Shea, Costa Mesa, CA (US)

(21) Appl. No.: 18/208,859

(22) Filed: Jun. 12, 2023

Related U.S. Application Data
(60) Provisional application No. 63/351,770, filed on Jun. 13, 2022.

(51) Int. Cl. G06F 9/48

(52) U.S. Cl. CPC G06F 9/4856

(57) ABSTRACT

Apparatus and methods for management and migration of functions or processes between two or more domains. In one or more exemplary embodiments, the functions or processes comprise virtual machines (VMs), and the methods and apparatus provide improved efficiency and reduced latency for such VM migrations between a first virtualized environment (e.g., a virtual configuration space or VDI) and a second virtualized environment by, e.g., enabling the first and second virtualized environments to operate simultaneously, for at least a period of time. In one variant, the methods and apparatus provide for enhanced data message pause functionality.

### PRIORITY AND RELATED APPLICATIONS

This application claims priority to co-owned and co-pending U.S. Provisional Patent Application Ser. No. 63/351,770 of the same title, filed Jun. 13, 2022, which is incorporated herein by reference in its entirety.

Additionally, this application is generally related to, and/or is useful with, one or more aspects of, subject matter contained in: co-owned U.S. patent application Ser. No. 16/566,829 filed Sep. 10, 2019, entitled “Methods and Apparatus for High-Speed Data Bus Connection and Fabric Management,” and issued as U.S. Pat. No. 11,593,291 on Feb. 28, 2023; U.S. patent application Ser. No. 17/079,288 filed Oct. 23, 2020, entitled “Methods and Apparatus for DMA Engine Descriptors for High Speed Data Systems,” and issued as U.S. Pat. No. 11,392,528 on Jul. 19, 2022; U.S. patent application Ser. No. 17/061,366 filed Oct. 1, 2020, entitled “Method and Apparatus for Fabric Interface Polling,” and issued as U.S. Pat. No. 11,593,288 on Feb. 28, 2023; U.S. patent application Ser. No. 17/016,228 filed Sep. 9, 2020, entitled “Methods and Apparatus for Network Interface Fabric Send/Receive Operations,” and issued as U.S. Pat. No. 11,403,247 on Aug. 2, 2022; and co-pending U.S. patent application Ser. No. 17/016,269 filed Sep. 9, 2020, entitled “Methods and Apparatus for Improved Polling Efficiency in Network Interface Fabrics,” each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Technological Field

The present disclosure relates generally and without limitation to the field of data buses, devices, interconnects such as e.g., fabrics, and networking and specifically, in one or more exemplary embodiments, to methods and apparatus for providing interconnection and data routing within fabrics comprising one or more host devices or processes and one or more destination devices or processes, including for migration of processes such as e.g., virtual machines (VMs).

### 2. Description of Related Technology

The presentation of virtualized device interfaces, such as e.g., the virtualization of a configuration space of a PCI family device (such as PCI, PCI-X, PCIe, CardBus, CXL, etc.) is known. The concept of virtualized device interfaces can further be generalized beyond PCI-family devices to any other device protocol which supports an ID-based register access space (aka the “configuration space” in the PCIe context).

Recent advances in, inter alia, switch technology allow for more complex transaction routing in switch designs. These advances allow for moving devices from the purview of one host to that of another host (or to Virtual Machine or VM on those hosts).

However, extant configurations suffer from several disabilities, including for instance that they do not allow for the hot-migration of ownership from one host to another, either as base hosts, or as hosts that feature Hypervisor systems on them supporting Virtual Machines, where on the Virtual Machine load will be migrated.

Accordingly, improved apparatus, methods, and systems are needed to address the foregoing, including providing improved efficiency and reduced latency for such VM migrations between originating and destination virtual machine device instantiations. More specifically, such apparatus, methods, and systems could, inter alia, substantially reduce the time that I/O traffic must be halted during migration and minimize virtual machine (VM) downtime in such migrations, thereby reducing latency.

### SUMMARY

The present disclosure addresses the foregoing deficiencies by providing, inter alia, apparatus, systems, methods, and computer-readable apparatus for supporting, inter alia, efficient and effective process migration and pausing of data communications within a fabric or other networked system.

In one aspect of the disclosure, methods and apparatus for migration of one or more processes within a data processing system are disclosed. In one embodiment, an originating function, process or entity (e.g., a Virtual Device Instantiation) exists during migration, and during migration a destination function, process or entity (e.g., a second Virtual Device Instantiation) exists at the same time as the originating VDI for at least a period of time, e.g., simultaneous operation (at least in part) by the Source VDI and the Destination (VDI).

In one implementation, the existence during migration comprises one or more aspect of the destination function, entity or process (e.g., VDI) is/are detectable or accessible by another destination-side entity (e.g., destination Physical Host). This detectability or accessibility may include, without limitation, the ability to send or receive protocol transactions to the VDI by its respective host such as reading or writing registers, sending or receiving interrupts, accepting upstream message types for detection or error reporting or experiencing any detectable side-effect of any of the destination Virtual Device Instantiation by a destination Physical Host (PH), while at the same time allowing one or more functions or processes to be performed on the originating Virtual Device Instantiation, such as by the originating Physical Host (including any originating VM processes).

In another aspect of the disclosure, methods and apparatus for the reduction of delay or latency within e.g., a migration operation, are disclosed. In one embodiment, simultaneous operation of source and destination functions, processes or entities (e.g., VDIs) allows the source host (and VM) to continue operations to the I/O device while the destination host undergoes migration setup operations. This significantly reduces the time where I/O traffic must be blocked from ongoing operations during the migration.

In a further aspect of the disclosure, methods and apparatus for pausing bus traffic are disclosed. In one embodiment, the pausing is implemented during a VM migration process, and I/O traffic (bus protocol traffic) (i) from the physical endpoint device function to the originating host (or destination host), and/or (ii) from the originating host or destination host to the physical endpoint device function, is paused. In one implementation, the pausing occurs inside an I/O traffic switch routing fabric itself (not in the physical endpoint device function) and not in the physical host functions, such that the physical endpoint device function's and physical host systems only awareness of such a pause may occur if/when the fabric's flow control mechanisms are invoked to prevent the endpoint device from transmitting additional I/O (because such entities detect a protocol flow control stop (backflow) condition).

In one variant of the foregoing, I/O traffic routing is then changed within the I/O routing fabric (during VM migration), and the fabric I/O routing operations that were previously paused are then unpaused or otherwise permitted to process and, such traffic is then unblocked and completed at e.g., the destination Physical Host and real endpoint function.

In yet a further aspect of the disclosure, methods and apparatus configured to provide enhanced pausing and blocking behavior are described. In one embodiment, such methods and apparatus implement a specific process sequence that allows I/O traffic to be blocked (e.g., using a traffic routing block/pause function that causes a flow control condition) and wherein the originating host and destination host may have different bus IDs (fabric address ID's), but which allows non-address-routed I/O transactions to drain from the I/O subsystem and complete before all remaining traffic is blocked using the traffic flow control block mechanism. The use of the special drain sequence mechanism ensures that only address-routed traffic is present in the I/O subsystem when traffic is blocked using the address pause mechanism. This process sequence is highly advantageous because, inter alia, it prevents non-address-routed traffic from being present in the blocked back-pressured I/O fabric queues, as such traffic cannot be successfully routed after a fabric route change. Thus, the exemplary process sequence allows address-routed traffic to be paused and re-routed after unpausing, and further allows non-address-routed traffic (such as read completions and configuration read completions) to be drained from the system without knowledge by the VM (or another host software) prior to the I/O traffic pause. As such, both host and device are unaware of the traffic pause and traffic rerouting (other than via the passage of time). Of further benefit is the fact that in the exemplary embodiments, no special operations in the VM need take place, other than the stopping of the execution of the VM in processing VM guest OS or VM application software execution.

In another embodiment, such methods and apparatus implement a specific process sequence that allows, inter alia, I/O traffic to be blocked and wherein the originating and destination hosts must have the same fabric IDs. In this embodiment, the draining of non-address-routed traffic during the migration route switch over process is not necessary and only the flow control blocking mechanism is used without regard for draining non-address-routed traffic before blocking.

In another aspect of the disclosure, a system is described. In one embodiment, the system comprises one or more data fabrics (e.g., a PCIe-compliant switch fabric), a source host (e.g., a server system), and a destination host. The source and destination hosts each have one or more virtualized domains or endpoints associated therewith. Within the fabric/switch, one or more pause points for traffic are defined, and a protocol implemented whereby all types of traffic are blocked from arrival at the real physical function, but where such operations are completed within the switch fabric by the VDI emulation implementation instead of the real fabric device. The VDI emulation supported types of operations can proceed (at their respected hosts), such as during a migration of a VM from one of the hosts to the other. In another embodiment, a pausing/blocking mechanism which allows at least two of the virtualized endpoints (and at least portions of their respective hosts) to simultaneously communicate with the real endpoint allows fewer traffic types to be completed solely by the destination VDI emulation (as they can be conveyed to the real endpoint for complete) so as to, inter alia, reduce latency.

In another aspect, methods and apparatus for providing indication of a completed transaction are disclosed. In one embodiment, an entity (e.g., VDI) is used to appear to one or more other entities or processes to complete transactions. In one implementation, two use cases exist; i.e., 1) no-simultaneous routing allowed, and 2) simultaneous routing allowed. In no simultaneous routing, the destination VDI is used as a complete or comprehensive emulator, because it cannot “talk” to the real endpoint until the source is finished with it (because only one route is allowed). In simultaneous routing capable fabrics, two or more routes can coexist simultaneously, and in that case the destination VDI may elect to pass through some transactions to the real endpoint device (and have the endpoint complete them) rather than to emulate them fully in the VDI and complete them in the VDI without the real endpoint ever having been aware of them.

In another aspect, a computer readable apparatus is disclosed. In one embodiment, the computer readable apparatus comprises a storage device (e.g., SSD, HDD, memory) associated with one or more hosts of the foregoing system.

In a further aspect, a fabric is disclosed. In one embodiment, the fabric comprises a PCIe-compliant switch or switching fabric configured for use with one or more pause points and two or more virtualized endpoints (e.g., VDIs) and so as to implement the pausing/blocking mechanism described herein, as well as reduction of setup and other latencies associated with e.g., VM migration.

In a further aspect, a method of migrating virtualized entities (e.g., VMs) is disclosed.

In yet another aspect, a host device is disclosed. In one embodiment, the host device comprises a computerized apparatus (e.g., PC, cluster node, server, or server blade) having one or more VMs associated therewith, and capable of data communication with a data fabric (e.g., using PCIe-based protocols) as well as one or more other hosts.

Other features and advantages of the present disclosure will immediately be recognized by persons of ordinary skill in the art with reference to the attached drawing(s) and detailed description of exemplary embodiments as given below.

### BRIEF DESCRIPTION OF THE DRAWINGS

FIG. 1 is a logical block diagram illustrating one exemplary embodiment of a data processing system according to the present disclosure.

FIG. 1A is a logical block diagram illustrating one exemplary embodiment of a data processing system with address-routed and non-address-routed traffic, according to the present disclosure.

FIG. 2 is a logical flow diagram illustrating one embodiment of a method of operating a data system so as to provide simultaneous originator and destination virtual device processing according to the present disclosure.

FIG. 3A is a logical flow diagram illustrating one embodiment of operating a pausing mechanism within a data processing system, according to the present disclosure.

FIG. 3B is a logical flow diagram illustrating the embodiment of operating the pausing mechanism within the data processing system of FIG. 3A (continued), according to the present disclosure.

All Figures disclosed herein are © Copyright 2022 GigaIO Networks. All rights reserved.

### DETAILED DESCRIPTION

Reference is now made to the drawings wherein like numerals refer to like parts throughout.

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the term “computer program” or “software” is meant to include any sequence or human or machine cognizable steps which perform a function. Such program may be rendered in virtually any programming language or environment including, for example, C/C++, Fortran, COBOL, PASCAL, Python, Ruby, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like, and may comprise one or more applications.

As used herein, the terms “device” or “host device” include, but are not limited to, servers or server farms, set-top boxes (e.g., DSTBs), gateways, modems, personal computers (PCs), and minicomputers, whether desktop, laptop, or otherwise, as well as mobile devices such as handheld computers, PDAs, personal media devices (PMDs), tablets, “phablets”, smartphones, vehicle infotainment systems or portions thereof, distributed computing systems or clusters, VR and AR systems, gaming systems, or any other computerized device.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “memory” includes any type of integrated circuit or other storage device adapted for storing digital data including, without limitation, ROM, PROM, EEPROM, DRAM, SDRAM, DDR/2/3/4/5/6 SDRAM, EDO/FPMS, RLDRAM, SRAM, “flash” memory (e.g., NAND/NOR), 3D memory, and PSRAM.

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, GPUs (graphics processing units), microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the term “network” refers without limitation to any wireline, wireless, optical, or other medium capable of transmitting data between two or more devices, entities or processes.

As used herein, the term “network interface” refers to any signal or data interface with a component or network including, without limitation, those of the PCI, PCIe, FireWire (e.g., FW400, FW800, etc.), USB (e.g., USB 2.0, 3.0. OTG), Ethernet (e.g., 10/100/1000 (Gigabit Ethernet), 10-Gig-E, etc.), families.

As used herein, the term “PCIe” or “Peripheral Component Interconnect Express” refers without limitation to the technology described in PCI-Express Base Specification, Version 1.0a (2003), Version 1.1 (Mar. 8, 2005), Version 2.0 (Dec. 20, 2006), Version 2.1 (Mar. 4, 2009), Version 3.0 (Oct. 23, 2014), Version 3.1 (Dec. 7, 2015), Version 4.0 (Oct. 5, 2017), and Version 5.0 (Jun. 5, 2018, and May 2019), each of the foregoing incorporated herein by reference in its entirety, and any subsequent versions thereof.

As used herein, the term “server” refers without limitation to any computerized component, system or entity regardless of form which is adapted to provide data, files, applications, content, or other services to one or more other devices or entities on a computer network.

As used herein, the term “storage” refers without limitation to computer hard drives, DVR device, memory, RAID devices or arrays, SSDs, optical media (e.g., CD-ROMs, Laserdiscs, DVD, Blu-Ray, etc.), or any other devices or media capable of storing content or other information.

### Overview

The present disclosure describes methods and apparatus for, among other things, migrating one or more processes within a data processing system.

In one aspect, a system allows and makes use of two or more simultaneous VDIs (e.g., virtual configuration space(s)) being exposed, e.g., one to the originator (e.g., source host), and a second one to the destination (e.g., destination host). That is, in exemplary implementations described herein, the originating and destination Virtual Device Instantiations exist for at least a period of time simultaneously.

By creating a configuration-space-only DEST VDI instance, the DEST OS can then do enumeration, discovery, and even driver load, which saves significant amounts of time (microseconds to multi-seconds of time), thereby shortening overall migration times.

Partial operation of a DEST VDI entails supporting simulated configuration reads and write protocol cycles, and generally will “end”, and will entail DEST VDI operation to block on wait-on-termination the SOURCE VDI in a range of responses. At the earliest point, the configuration space write of the device's control bits (in the PCIe bus instantiation the CONTROL register) for the MEMORY SPACE enable bit, and at the latest point, device specific (DEST VDI implementation specific based on device class/vendor/model) memory address offsets in the memory address space supported by the DEST VDI.

Specifically, in one variant, the destination Virtual Device Instantiation comes into being (is detectable or accessible) while at the same time, the previously created originating Virtual Device Instantiation remains in existence (advantageously allowing the originating Physical Host to perform at least some detection and access operations during that time period, while also allowing the destination Physical Host(s) to use the Destination Virtual Device Instantiation to perform at least some detection and access operations). Extant solutions preclude such simultaneous operation of originating and destination Virtual Machine Device Instantiations.

The exemplary methodology, apparatus and systems described herein also seek to first pause downstream traffic within the fabric at e.g., a blocking point (the downstream blocking point), and allowing downstream commands that have already passed this blocking point to drain downstream to the physical endpoint device function. In the case of commands that require immediate (or near immediate) responses, the physical endpoint device function is able to complete (and thus drain) such commands from the outstanding set from the host such that only I/O traffic commands that require completions that have not passed the downstream blocking point are outstanding. This approach allows all completion type traffic (for instance in the exemplary PCIe I/O protocol, memory read completions, configuration cycle read completions) for I/O traffic commands that have passed the downstream blocking point may complete in the upstream direction before upstream traffic is blocked (at the upstream blocking point) within the I/O fabric.

Additionally, the physical endpoint device function is allowed to keep sending upstream traffic that is not completion-based upstream (from device to host) at its leisure until such time as protocol flow control prevents the device from transmitting upstream (only because flow control conditions prevent it from doing so, as described above), and all return device-to-host completion traffic for the corresponding downstream I/O command flows is drained. Eventually, such traffic would not include completion traffic, because such completion traffic was allowed to complete before blocking the upstream traffic at the fabric upstream blocking point for this physical endpoint device function. This mechanism advantageously allows, inter alia, the physical endpoint device function to be unaware of any pausing, quiescing, or identity change that occurs between its communication.

### DETAILED DESCRIPTION OF EXEMPLARY EMBODIMENTS

Exemplary embodiments of the present disclosure are now described in detail. While these embodiments are primarily discussed in the context of a PCIe-based component or system and related methods, such as those exemplary embodiments described herein and/or those compliant with the PCIe Base Specification e.g., Revision 3.0, 4.0, 5.0 or later, each incorporated herein by reference in its entirety, and/or those set forth in U.S. patent application Ser. No. 16/566,829 filed Sep. 10, 2019 and entitled “Methods and Apparatus for High-Speed Data Bus Connection and Fabric Management,” Ser. No. 17/079,288 filed Oct. 23, 2020 and entitled “Methods and Apparatus for DMA Engine Descriptors for High Speed Data Systems,” Ser. No. 17/061,366 filed Oct. 1, 2020 and entitled “Method and Apparatus for Fabric Interface Polling,” Ser. No. 17/016,228 filed Sep. 9, 2020 and entitled “Methods and Apparatus for Network Interface Fabric Send/Receive Operations,” and Ser. No. 17/016,269 filed Sep. 9, 2020 and entitled “Methods and Apparatus for Improved Polling Efficiency in Network Interface Fabrics,” each of the foregoing previously incorporated herein, as well as e.g., those set forth in U.S. Pat. Nos. 9,448,957, 9,152,597, 8,868,777, and 8,463,934, each entitled “Unified system area network and switch” and incorporated herein by reference in its entirety, the various aspects of the present disclosure are in no way so limited, and in fact may be used in any number of other applications and/or system architectures or topologies (whether PCIe-based or otherwise), the foregoing being merely exemplary. In fact, the various aspects of the disclosure are useful with, inter alia, other types of fabrics, bus architectures, and protocols.

In the context of the exemplary embodiments, it is useful to further define certain terms or concepts for purposes of illustration of the various aspects of the present disclosure. It will be appreciated that, as with the terms set forth supra, the various aspects of the disclosure are in no way limited by such definitions or terms, unless specifically stated herein.
1. Physical Host System: A host system that can attach to an I/O device via, e.g., an I/O fabric.
2. Virtual Host System: A host system that is at least partly virtualized in at least one aspect thereof, such as e.g., a Virtual Machine (VM), Hypervisor, or other such system or process.
3. Physical Domain (PD, HvD): The endpoint and switch tree owned by and rooted at a physical host and its Root Port (defining the tree top) as defined by the PCIe and other specifications. This is commonly referred to as a “Host Virtual Domain (HvD)” in switch components that support attachment to multiple PDs at the same time, and the terms PD and HvD can be synonymous in this usage.
4. Virtual Device Instantiation (VDI): The property of a virtual endpoint implementation solution wherein some portion (which can be any portion) of the design becomes visible (detectable) to a specific host system and devices (in a specific Physical Domain. Two virtual instantiations can be different if the physical host and devices that can detect them, are in two different Physical Domains. Two virtual instantiations can be the same if a Physical Domain of the host(s), and that of devices that can detect or access the instantiation, are the same Physical Domain.
5. Originating Physical Host (OPH): A physical host system that, pre-migration, can detect and access a particular virtual endpoint instantiation (e.g., Virtual Instantiation) of a physical endpoint device function (the Originating VDI). In one exemplary configuration, the OPH is the physical host that houses a virtual machine that has access to, and effective ownership of, the virtual device instantiation before such virtual machine is migrated to another physical host. This is an “original” location of the virtual machine (VM) before migration.
6. Destination Physical Host (DPH): A physical host system that, after migration, can detect and access a virtual instantiation of a physical endpoint device function (e.g., the destination VDI) for use and effect. Advantageously, in some implementations of the present disclosure, the destination physical host may also be capable of accessing the destination VDI during one or more portions of the migration process (such as at the same time that the originating physical host is accessing the Originating VDI.
7. Originating Virtual Device Instantiation (Originating VDI or OVDI): The VDI that is used by the Originating Physical Host to access a physical endpoint device function. It is noted that, based on the definition of VDI's, the OVDI cannot be the same VDI as that used by the Destination Physical Host to access a physical device function after (or during) virtual machine (VM) migration, because the Originating Host and Destination Host are in two different Physical Domains (e.g., HvDs) and thus must use one or more different VDIs to access the physical endpoint device function.
8. Destination Virtual Device Instantiation (Destination VDI or DVDI): The VDI that is used by the Destination Physical Host to access a physical endpoint device function that is being transferred for use by the new location (on the Destination Physical Host) of a virtual machine that is being migrated (from the Originating to the Destination Physical Host). By definition, the Destination Virtual Device Instantiation cannot be the same VDI as that used by the Originating Physical Host because the Originating physical host is in a different Physical Domain (HvD) than the Destination Host, and thus the Destination Host's detected and accessed VDI cannot be the same as the Originating Host's (Originating VDI) because the two VDI operate and exist in two different Physical Domains (e.g., HvDs) and are by definition different VDIs.

### Exemplary System and Components—

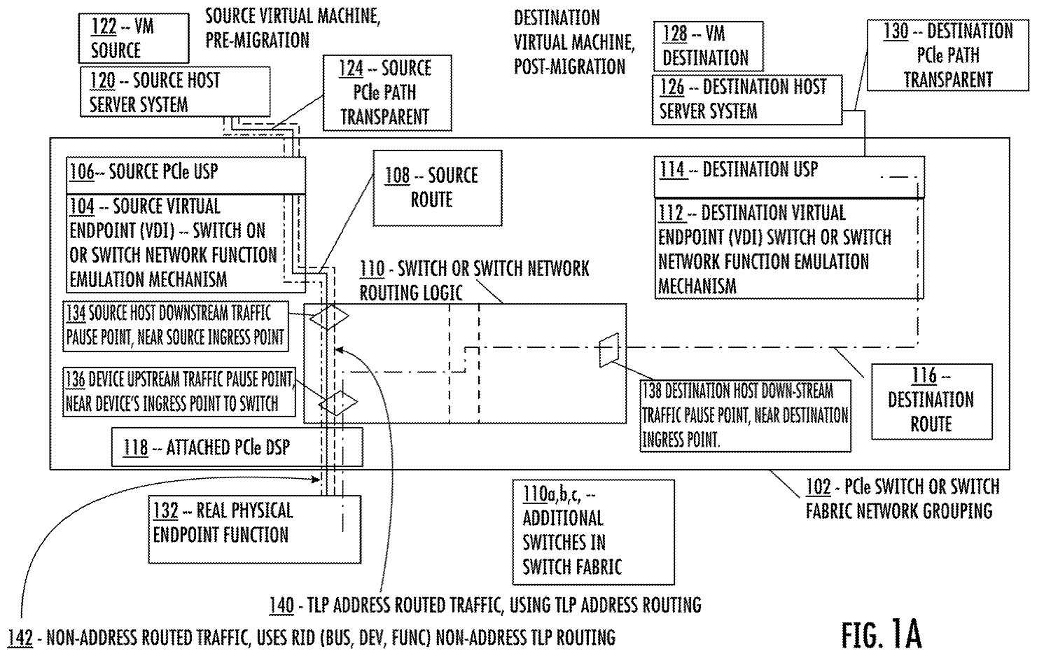

Referring now to FIG. 1, one exemplary embodiment of a system 100 configured in accordance with various aspects of the present disclosure is shown and described.

As illustrated in FIG. 1, the exemplary system 100 includes, inter alia, one or more I/O fabrics 102 (which in one or more exemplary implementations thereof include at least one of a PCIe switch or switch network), one or more source Virtual Endpoint Interfaces (VDIs) 104, one or more source host physical attachments 106 to the I/O fabric (e.g., in one PCIe-based embodiment, the source PCIe port interface on the upstream side of the I/O fabric for the source host, herein referred to as the Upstream Port (USP) for the source host), and one or more source routes 108, which in one implementation includes the route within the I/O fabric that I/O transactions follow (are routed upon) between the source host and the device. In the exemplary embodiment, the source route 108 is defined by switch-specific rules that describe to where and in what manner I/O transactions from one particular PCIe tree (fabric) bus, device, function that describes a real endpoint device (e.g., that of real endpoint function 132, described infra) routed relative to one particular PCIe tee (fabric), bus, device, function that describes the source host. These rules are logical, but generally have a physical hardware routing analog within the switch or switch fabric.

The system 100 of FIG. 1 further comprises fabric routing logic 110 (which in one exemplary embodiment includes one or more switches or switch networks, and/or generalized fabric infrastructure for packet routing, which may be distributed among e.g., two or more fabric elements), one or more destination Virtual Endpoint Interfaces 112 (e.g., VDIs, aka Virtual Device Interfaces) for the destination host in an ownership routing change, such as that involved in a Virtual Machine Migration operation, as well as one or more destination host physical attachments 114 to the I/O Fabric (in the exemplary PCIe-based implementation, the destination PCIe port interface on the upstream side of the I/O fabric for the destination host, call the Upstream Port (USP) for the destination host).

In the system 100, one or more destination routes 116 are also provided; in one implementation, these comprise route(s) within the I/O fabric which the I/O transactions follow (are routed upon) between the destination host and the device. The destination route 116 is in one embodiment defined by switch-specific rules that describe to where and in what manner I/O transactions from one particular PCIe tree (fabric) bus, device, function that describes a real endpoint device as being routed relative to one particular PCIe tree (fabric), bus, device, function that describes the source host. As with the source route 108 referenced above, the destination route 116 rules are logical, but generally have a physical hardware routing analog within the switch or switch fabric.

The foregoing routes (108 and 116, respectively) can be thought of in another way; i.e., a source to destination route change, with source to destination VDI instantiations, and typically with a migration of VM (although a migration of just hosts, without VM migration, can also be performed). As described in greater detail elsewhere herein, these routes (108 and 116, respectively) support at least functionalities:
1. VDI instances being created and (at least in part) overlapping in time;
2. use of the flow control pause mechanism:
   a. by itself, when the source and destination ID's are the same; or
   b. In conjunction with a special sequence described infra, which is needed to drain non-Address-routed transactions before using the flow control pause mechanism; and
3. use of the aforementioned special sequence itself, such as for draining non-address-routed transactions from the fabric before pausing traffic.

In the illustrated embodiment of FIG. 1, a PCIe-compliant DSP (downstream port) 118 is also provided in association with the fabric. In one implementation, this DSP 118 comprises a port (one of many) on the downstream side of the switch and is a sub-component of the PCIe switch device. For instance, upstream-destined traffic may start at the DSP 118. Moreover, the DSP (and upstream port, or USP) can be used as a reference for the location of the pause points; e.g. upstream of the DSP, and downstream of the USP.

As shown in FIG. 1, the exemplary system 100 further includes one or more source host systems 120 (e.g., a Source Host, Source), which in one implementation includes the physical server system with a physical HBA adapter (one embodiment of which is a PCIe adapter), and which may host a hypervisor software system that allow the creation of one or more virtual machines using, e.g., software and hardware acceleration mechanisms.

One or more source virtual machine instances 122 (e.g., Source VM, VM—Source) are also utilized; in one embodiment, these comprise a software instantiation and simulation or virtualization of a physical system that is comprised of software elements. Such a “computer system” runs on simulated hardware in most cases and not directly on actual physical hardware (as does a “host system”). Some VM however are given direct access and control over specific real hardware elements, such as specific PCIe devices. In some implementations, aspects of such direct control over actual hardware by a virtual machine (VM), and by its hosting hypervisor software running on the base host system, are provided by the mechanisms described herein.

A source PCIe transparent pathway 124 is also illustrated on FIG. 1. In one exemplary embodiment, this is the PCIe standard transparent pathway from the source VM to the source VDI that is associated for the device function that is utilized by the source VM (or source host system).

A destination host system 126 (e.g., Destination Host) is also illustrated on FIG. 1. The destination host system 126, in one exemplary embodiment, includes a second (contrasted to the first source host system) system that is wholly separate from the source host system 120, running on its own hardware, but attached to or in data communication with the same switch or switch fabric as the source host system 120.

One or more destination Virtual Machine instances 128 (e.g., Destination VM, Destination Virtual Machine, VM—DEST) are present in the system 100 of FIG. 1 as well, as is/are one or more destination PCIe transparent pathways 130. These pathways include, in one embodiment, PCIe standard transparent pathways from a destination VM (or destination host system) to a source VDI that is associated with the real endpoint function, discussed below in greater detail, that is being utilized by the source and destination VM (or host systems).

The exemplary system 100 of FIG. 1 also defines one or more real endpoint functions 132. In the exemplary embodiment, these functions 132 include one or more physical PCIe devices with one or more functions, one or more of which is/are being utilized by the source VM 122 (or source host 120) and destination VM 128 (or destination host 126), and in specific, a single function (of possibly many) as described in the present disclosure.

Also illustrated in FIG. 1 is a “pause point” 134; in one embodiment, this pause-point 134 includes a source host downstream traffic device pause point (e.g., Source Downstream {Block Point, Pause Point}). In this embodiment, this source host downstream traffic device pause point includes a point within the switch or switch fabric wherein I/O traffic traveling in the downstream direction (from source host to device) can be blocked/paused, such as via using a switch or switch fabric traffic flow pause mechanism. When traffic is blocked/paused, the switch or switch fabric will continue to accept downstream flow traffic destined for the device if it has remaining flow credits or capacity that allow for transaction ingress, or another mechanism via which the traffic can be handled. Downstream traffic will not be further routed in the switch or switch fabric past this point when traffic is paused or blocked. When traffic is resumed (unpaused, unblocked) then these downstream destined I/O transactions will be routed according to the routing rules in place when routing of traffic is resumed.

Similarly, one or more upstream pause points 136 (e.g., Upstream Traffic Device Pause Point {Block Point, Pause Point}) may be utilized. In the exemplary embodiment, this upstream pause point 136 is a point within the switch or switch fabric wherein I/O traffic traveling in the upstream direction (from device to host) can be blocked/paused, such as via using a switch or switch fabric traffic flow pause mechanism. When traffic is paused in such a manner, the switch will continue to accept upstream I/O traffic if it has remaining flow control credits that allow for transaction ingress in the upstream direction, or other handling mechanism exists. Upstream traffic will not be further routed in the switch or switch fabric past this point when traffic is paused. When traffic is resumed (unpaused, unblocked), then these upstream destined I/O transactions will be routed according to the routing rules in place when routing of traffic is resumed.

It is noted that the downstream and upstream pause points described above may or may not, depending on the configuration, may comprise the same point(s).

Yet further, a destination host downstream traffic device pause point 138 (e.g., Destination Downstream {Block Point, Pause Point}) is included within the system 100. In one embodiment, this destination host downstream traffic device pause point 138 is a point within the switch or switch fabric wherein I/O traffic traveling in the downstream direction (from destination host to device; contrast source host described above) can be blocked using e.g., a switch or switch fabric traffic flow pause mechanism. Similar to the other pause points above (134, 136), the destination host downstream pause point 138 may be configured such that when traffic is blocked/paused, the switch or switch fabric will continue to accept downstream flow traffic destined for the device if it has remaining flow credits that allow for transaction ingress (or another available handling mechanism). Downstream traffic will not be further routed in the switch or switch fabric past this point when traffic is paused. When traffic is resumed (unpaused, unblocked) then these Downstream destined I/O transactions will be routed according to the routing rules in place when routing of traffic is resumed.

Referring now to FIG. 1A, another exemplary embodiment of a system 100 configured with address-routed and non-address-routed traffic, in accordance with various aspects of the present disclosure, is shown and described.

Various operations of the system 100 may also utilize so-called “address routed traffic” 140. For example, in one embodiment, I/O transactions that follow a route (such as 108, 116, 124, 130) make use of a steering mechanism that determines where the transaction unit (packet) will be sent at each step, which is determined by examining the Address field in the I/O transaction packet, which is a field that holds the memory or I/O address with which the transaction is associated.

Conversely, non-address routed traffic 142 may also be utilized within the system 100. Specifically, in one implementation, I/O transactions that follow a route (such as 108, 116, 124, 130) make use of a steering mechanism that determines where the transaction unit (packet) will be sent at each step which is not determined using the Address field of the transaction unit (packet), but rather by some other means. Examples of non-address routed traffic would include, without limitation, READ completions or Configuration Space READ Completions in the PCIe protocol, which are routed using the Routing Identifier (an ID identifying the original sender of the READ or Configuration Space READ request transaction) in order to determine the routing at each route step in the return path to the original sender. These packets use different information from the Address to determine their routing mechanism.

It is noted that although FIG. 1A shows address-routed traffic 140 and non-address-routed traffic 142 only on the route of the source PCIe transparent pathway 124 and source route 108, such route is merely exemplary/non-limiting, and other configurations are contemplated within the present disclosure. For example, address-routed traffic 140 can be utilized on the source PCIe transparent pathway 124 and source route 108, and non-address-routed traffic 142 can be utilized for destination PCIe transparent pathway 130 and destination route 116; and/or address-routed traffic 140 and non-address-routed traffic 142 can be utilized in destination PCIe transparent pathway 130 and destination route 116.

Additionally, in the exemplary embodiment of FIG. 1A, Transaction Layer Protocol (TLP) routing is utilized; however, the present disclosure contemplates use of other protocols and is not limited to use of TLP.

### Simultaneous Interface Utilization/Presentation—

As discussed previously herein, the presentation of virtualized device interfaces, e.g., the virtualization of a PCI family devices configuration space (PCI, PCI-X, PCIe, CardBus, CXL, etc.) is known. In the context of the present disclosure, the term VDI (Virtual Device Interface) is used to describe the virtualized configuration space.

Despite recent advances in switch technology, current designs do not allow for the migration of hardware from one host system to another without a reboot of the host systems, aka “cold migration.”

Hot migration of a VM is the migration of a VM (or workload on a host) from one system to another without a perceptible loss in user function (typically for 1 second or less). Hot migration of a VM with direct hardware access requires the transfer in ownership and access of the direct hardware from a source host system (with source VM) to a destination host system, with destination VM instantiation (a hot migration of both the VM, and the associated direct access hardware that the VM is using.)

So-called Direct-Hardware-Access VM Hot Migration (DHA VM Hot Migration) thus involves the transfer of ownership from the source host (who has original direct access) to another destination host (who obtains final direct access, as the source host eventually loses access at the completion of the migration process). The two hosts may or may not feature hypervisor systems on them supporting VMs. For DHA VM Hot Migration, VM and hypervisors are present on the hosts, and the source host 120 (FIG. 1) holds the originating source VM 122, and the target of the migration, the destination host 126 will eventually instantiate the relocated VM image in the form of the destination VM 128. Note that the source VM 122 and the destination VM 128 both have direct hardware access to one or more real physical endpoint functions 132 via the mechanism of endpoint virtualization realized via the functionality of the source VDI 104 and destination VDI 112. Moreover, there is an ability of these adjustments in VDI implementation for the VDI to coexist in the source and destination instances simultaneously in time (for any period of time overlap), and in the use of a the I/O fabric's flow control mechanism (to be used as a traffic stop mechanism after a pausing of the traffic internal to the switch fabric): upstream of the lower upstream I/O traffic fabric ingress point at the downstream port (DSP) 118, and downstream of the upper interfaces downstream I/O traffic fabric ingress points at the upstream port (USP) 106 (source), and destination USP 114.

Advantageously, the various aspects of the present disclosure provide for, inter alia, such hot-migration of device ownership between e.g., a source system, to a destination system, including the exemplary specific case of Direct-Hardware-Access VM migration, which for the two hosts involved is just a subset of overall device ownership usage for each of the two host systems. Moreover, aspects of the disclosure provide for the sub-ownership (or sub-leased ownership) of a VM in a source system, and a VM in a destination system. The concepts introduced here apply to, inter alia, any protocol that utilizes an ID-based register address space (such as that found in PCI, PCIe, CXL, and many other protocols), and hence the exemplary PCIe-based variants described herein are purely illustrative of the broader concepts.

It is noted that unlike some extant approaches, the exemplary configurations of the present disclosure are not restricted to only originating and destination Virtual Device Instantiations only existing in mutual exclusion (i.e., never at the same time). This presents a significant improvement, overcoming the limitations that (i) only one host can see and own the VDI, and (ii) there can only be one VDI in existence for a real physical device at one time. In contrast, the present disclosure allows and makes use of two or more simultaneous VDIs (e.g., virtual configuration space(s)) being exposed, e.g., one to the originator (e.g., source host), and a second one to the destination (e.g., destination host). In exemplary implementations described herein, the originating and destination Virtual Device Instantiations exist for at least a period of time simultaneously. Specifically, in one variant, the destination Virtual Device Instantiation comes into being (is detectable or accessible) while at the same time, the previously created originating Virtual Device Instantiation remains in existence (advantageously allowing the originating Physical Host to perform at least some detection and access operations during that time period, while also allowing the destination Physical Host(s) to use the Destination Virtual Device Instantiation to perform at least some detection and access operations). Extant solutions preclude such simultaneous operation of originating and destination Virtual Machine Device Instantiations.

It will also be appreciated that in some embodiments, the destination VDI may only be partial (e.g., allow only some operations). Another benefit of the capability of the present disclosure whereby both the source and destination VDI interfaces exist simultaneously is the substantial reduction in the time that I/O traffic must be halted during migration. The destination (e.g., destination Physical Host) may proceed with migration setup operations of that Physical Host's resident operating system, while at the same time, the originator (e.g., originating VDI) is still operating allowing the originating VDI to service the originating VM and originating Physical Host without I/O traffic yet being paused.

Destination host operations include (but are not limited to) processing device hot-add events (e.g., those of the Destination VDI), detecting and enumerating the destination VDI instance during normal operating system processing, and of allowing host operating system operations that may configure integrated or hosted virtual machine operations to a destination VM instance (e.g., the copy of the VM on the destination host, on the destination base OS, running on the destination Physical Host) for the purpose of “plumbing” and routing setup in the host OS; e.g., establishing memory translations, creating appropriate IOMMU (Input Output Memory Management Unit) entries in the Destination host, or performing any other destination host software operations that require the detection and access of the destination VDI.

Originating host operations include, for example, all I/O operations, as the originating host typically continues to operate for a relatively longer period of time; e.g., until the final paused I/O sequence used to change ongoing I/O operations from the source host to the destination host (the route change). Allowing the originating VDI to operate while the destination VDI is in existence allows, inter alia, the originating VM to continue to operate while the destination host is creating the plumbing (such as destination VDI discovery, enumeration, driver loading, driver quiescing, hypervisor handoff, IOMMU entry creation (which can be dependent on Destination VDI identity discovery through enumeration)), while the originating VM continues to operate. This allows the time period when the originating VM must finally be frozen (and can no longer operate), but the destination VM is not yet ready to be operated, to be greatly shortened because the substantial initializing, setup, IOMMU entry, driver loading, driver pausing activities may either be completed, or at least substantially completed, before having to pause the originating VM in preparation for handoff migration to the copied and synchronized destination VM. The use of the destination VDI that exists at the same time as the originating VDI allows the destination host to complete substantial migration transition initialization activities while the originating host continues to operate, and thus diminishes the time during the migration when the VM must be offline and not performing active work or responding to external events. Minimizing the VM downtime in such migrations is thus one highly valuable aspect of the present disclosure.

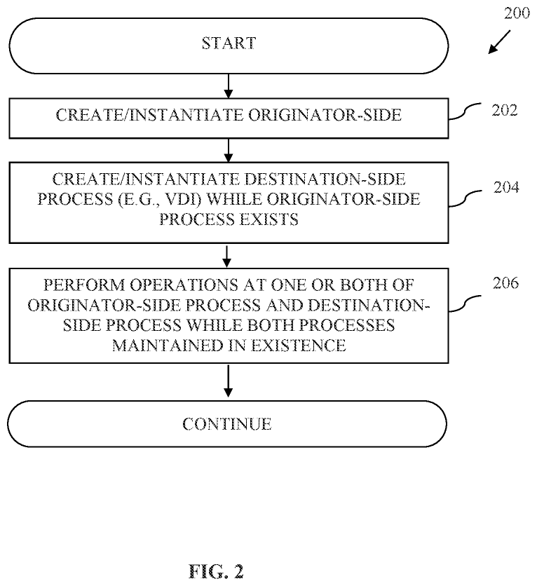

FIG. 2 herein illustrates one embodiment of a method 200 of operating a data system (such as the system 100 of FIG. 1) so as to provide simultaneous originator and destination virtual device processing according to the present disclosure (such as e.g., pursuant to one or more VM migrations).

As shown in FIG. 2, the method 200 first causes creation or instantiation of an originator-side process (e.g., a VDI of the type previously described herein, although this is but one possible process) per step 202.

Next, per step 204, a destination-side process is created or instantiated while the originator-side process of step 202 remains in existence (i.e., is accessible or can be detected/seen by e.g., a corresponding host).

Per step 206, the originator-side process and the destination-side process are maintained in co-existence for a period of time, during which one or more operations are performed. As previously described herein, such operation(s) may include e.g., operations conducted by the destinations-side/process in preparation for VM migration, thereby shortening or reducing a time or gap between when the originating-side process (e.g., VDI) must be paused and when the destination-side VDI is fully ready to operate.

### Exemplary Migration Pause Mechanisms—

Among other things, the present disclosure describes pause mechanisms useful in e.g., the VM migration process.

In one implementation of such mechanisms, physical endpoint device functions are maintained unaware of traffic re-routing within the I/O fabric due to e.g., downstream (from host to device I/O) traffic having stopped in a particular sequence, making the host or host virtual machine (I/O traffic source and sync) unaware of the operation. This approach has the effect that the I/O device believes that the pause is ascribed to another cause; e.g., for flow control reasons only. This allows traffic to be paused for a period of time, so as to carry out a I/O traffic routing change. Such traffic routing changes are necessary in VM migration, and useful in other situations such as where a VM needs to be paused, or other host operations need to be paused. In this description, I/O traffic from the host to the device is referred to as downstream traffic, while I/O traffic from the device to the host server system is referred to as upstream traffic, although these terms are merely for purposes of illustration and in no way limiting on the broader concepts described herein.

At a high level, the exemplary methodology described herein seeks to first pause downstream traffic within the fabric at e.g., a blocking point (the downstream blocking point), and allowing downstream commands that have already passed this blocking point to drain downstream to the physical endpoint device function 132. In the case of commands that require immediate (or near immediate) responses, the physical endpoint device function 132 is able to complete (and thus drain) such commands from the outstanding set from the host such that only I/O traffic commands that require completions that have not passed the downstream blocking point are outstanding. This approach allows all completion type traffic (for instance in the exemplary PCIe I/O protocol, memory read completions, configuration cycle read completions) for I/O traffic commands that have passed the downstream blocking point may complete in the upstream direction before upstream traffic is blocked (at the upstream blocking point) within the I/O fabric.

Additionally, the physical endpoint device function 132 is allowed to keep sending upstream traffic that is not completion-based upstream (from device to host) at its leisure until such time as protocol flow control prevents the device from transmitting upstream (only because flow control conditions prevent it from doing so, as described above), and all return device-to-host completion traffic for the corresponding downstream I/O command flows is drained. Eventually, such traffic would not include completion traffic, because such completion traffic was allowed to complete before blocking the upstream traffic at the fabric upstream blocking point for this physical endpoint device function. This mechanism advantageously allows, inter alia, the physical endpoint device function 132 to be unaware of any pausing, quiescing, or identity change that occurs between its communication.

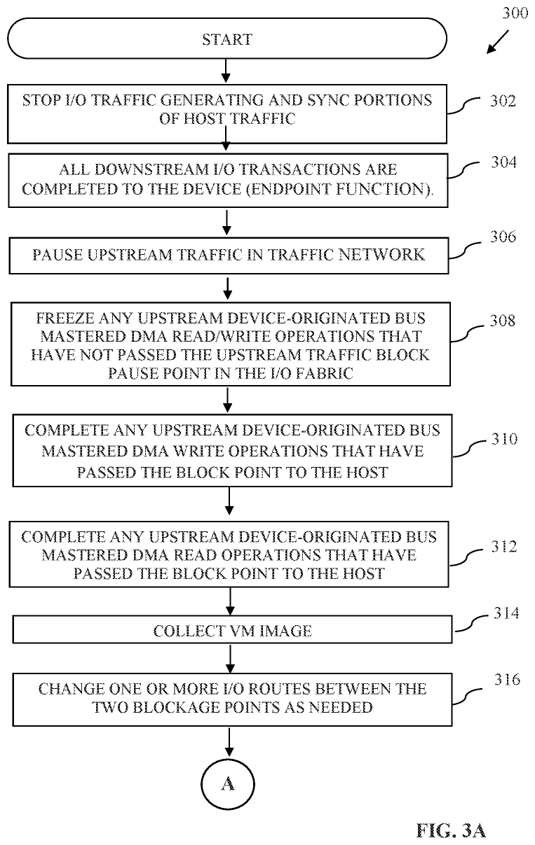

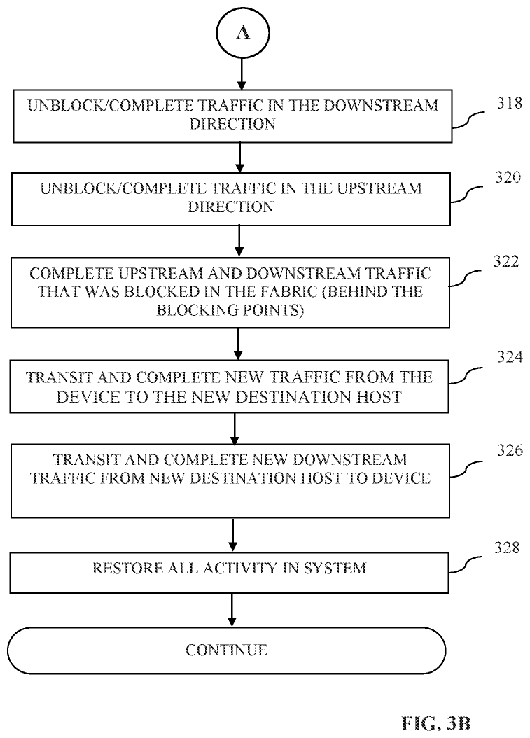

Referring now to FIG. 3A, one exemplary implementation of a methodology of providing pausing within a data system such as e.g., that of system 100 of FIG. 1 herein, is described. As shown in FIG. 3A, the first step 302 of the method 300 comprises a portion (e.g., the I/O traffic generating and sync portion) of the source host being stopped, such as at the software level. In one embodiment, the software is paused (for instance a VM's execution is frozen). In such exemplary case, the instruction execution is frozen, but the source/sync associated software memory image is not collected at this point. For example, a VM's execution is stopped, but the VM's memory image is not frozen or collected at this point, because the memory image is still subject to e.g., latent changes from hardware systems such as I/O traffic completions, and device I/O traffic generation.

It is also noted in passing that in the exemplary embodiment, the destination host in such case normally does not have any traffic, because the destination host at this point is unaware of the real hardware, is unaware of the destination VDI (until that point in the sequence when the destination VDI is created), and the Destination VM is not yet aware of the destination VDI, nor the real endpoint.

Next, per step 304 of the method 300, all downstream I/O transactions are completed to the device (endpoint function). In one implementation, downstream transactions that require a completion are completed by the I/O device and sent to the still active upstream link. At this point, both directions of I/O traffic are still active, only the software execution has been stopped. Protocol completion traffic (such as READ responses, and configuration READ responses) complete nearly immediately, and a very short wait in sequence control software (separate from the I/O source/sync software that has been stopped) facilitates the guarantee that all upstream completion traffic in response to downstream I/O command traffic completes.

At the completion of step 304, all downstream traffic and responsive upstream completions are now complete.

Per step 306, upstream traffic is then paused in the traffic network (not in the device itself). Any means of network pause may be used consistent with the present disclosure. For instance, in one implementation, a PCIe switch's ability to pause traffic on a particular link/channel is used as the basis of pausing the traffic. This type of traffic pause or blocking is observed at the I/O device as I/O protocol flow control blockage. The device will stop only because it is blocked by the flow control mechanism of the I/O link. It is noted that in some PCIe-based implementations, because the PCIe link credits are exhausted at the device, the device will stop until more credits are available using the flow control mechanism.

Per step 308, any upstream device-originated bus mastered DMA read and write operations that have not passed the host downstream traffic block pause point (134 or 138, described supra) are paused at the pause-point, such that no traffic passes the pause point. If flow control mechanisms allow traffic to be delivered prior to the pause point, it continues to be delivered until it reaches the pause point, where it stalls because of the pause condition. In one embodiment, using a PCIe fabric, the upstream traffic will continue to flow to the device upstream location pause point 136 (FIG. 1) and may flow between the real physical function 132 and the fabric DSP 118 until the fabric flow control mechanism blocks further traffic flow below the pause point 136. In the exemplary PCIe-based embodiment, this would occur when, for example, traffic buffers have filled, and I/O transaction link credits have been exhausted. In other embodiments, the flow control mechanism will vary, but a key functionality is that traffic will eventually stop because no more buffering exists (and thus the flow control mechanism will in effect cut off traffic flow) below (downstream of) the upstream I/O flow at the upstream traffic pause point 136, or above (upstream of) the flow at the downstream traffic pause-points 134, 138, as applicable.

Per step 310, any upstream device-originated bus mastered DMA write operations that have passed the block point continue to the host and are completed.

Per step 312, any upstream device-originated bus mastered DMA read (contrast: write) operations that have passed the block point continue to the host, and result in host to device completions in the downstream direction. These cycles are not yet blocked, and so they complete from the host to the device, and the device sees such cycles as satisfied and completed.

It is noted that in the exemplary embodiment described herein (i.e., in the context of a PCIe-based system), for upstream device-originated cycles behind the block point, completion timers will still apply and run in the device, as do acknowledgment (ACK) timers.

Referring again to FIG. 3A, downstream traffic is now blocked in the I/O fabric, causing any downstream traffic to backpressure and fill I/O queues downstream on the upstream side of the downstream block point. In the exemplary PCIe context, this condition appears as a PCIe downstream flow control situation to the host.

The memory image in the host is now safe to collect, as it is frozen since I/O traffic in both directions is now blocked. In the exemplary implementation, a few microseconds of delay are needed to allow the pre-block traffic to complete in the process shown in earlier steps of the method 300. For a VM migration application, the VM image is now collected at this point in time per step 314, or any other point before traffic is restarted.

Per step 316, one or more I/O routes can now be changed between the two blockage points as required for a migration ownership route change. For instance, traffic will be changed from the Source Route (108 of FIG. 1) to instead by routed via the Destination Route (116 of FIG. 1). The means of route description and route change varies with switch implementation, but the critical factor is that with traffic paused at the pause points, it is now safe to change the traffic routing within the switch, or within a switch fabric involving multiple switches.

The destination host completes its preparations for receiving inbound traffic preparations at this point. For instance, in the exemplary application where the host software migration is a VM migration, the target (destination) VM completes its IOMMU setup, physical page mapping, and most importantly, its IOVA setup in the IOMMU subsystem such that the IOVA's valid on the original host mapping for the VM are still valid on the new destination mapping of the VM on the new destination host in the VM migration. It will be appreciated that earlier ongoing synchronization preparation(s) can have occurred at any prior step, but finalization of VM preparation must occur before I/O traffic is unblocked and resumed.

Next, per step 318 of FIG. 3B, traffic is unblocked in the downstream direction (and completes). Similarly, per step 320, traffic is unblocked in the upstream direction, and because this traffic is not “completion” traffic (with completion traffic having been drained in one or more earlier steps of the exemplary method 300), it can be routed using the different route information (because it is address routed). It will be appreciated that in the illustrated embodiment, IOVA (I/O virtual address) assignments between the original host and the destination host must be preserved in the host reassignment, so that I/O interconnect addressing remains constant between the two routes, and thus the memory address-based routing can complete on the new routes.

Per step 322, upstream and downstream traffic that was blocked in the fabric (behind the blocking points) as previously described now completes.

Similarly, new traffic from the device to the new destination host can transit and complete (step 324).

New downstream traffic from the destination (new) host to the device can now transit and complete (step 326).

Lastly, per step 328, activity in the system is fully resumed.

It will be appreciated that while the foregoing methodology is described as a sequence of steps, two or more of the steps may be performed, whether in whole or part, in parallel with one another, as applicable. Moreover, the order of certain steps can be permuted consistent with achieving the goals and functionality described herein. Hence, the foregoing methodology is merely but one particular implementation of the broader principles and methodologies of the disclosure.

Moreover, it will be recognized that certain steps may be rendered unnecessary or optional under certain circumstances. Additionally, certain steps or functionality may be added to the disclosed embodiments. Furthermore, features from two or more of the methods may be combined. All such variations are considered to be encompassed within the disclosure disclosed and claimed herein.

The description set forth herein, in connection with the appended drawings, describes example configurations and does not represent all the examples that may be implemented or that are within the scope of any existing or later-added claims. The term “exemplary” used herein means “serving as an example, instance, or illustration,” and not “preferred” or “advantageous over other examples.”

The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

The functions described herein may be implemented in hardware, software executed by a processor, firmware, or any combination thereof. If implemented in software executed by a processor, the functions may be stored on or transmitted over as one or more instructions or code on a computer-readable apparatus (e.g., storage medium). Computer-readable media include both non-transitory computer storage media and communication media including any medium that facilitates transfer of a computer program from one place to another. A non-transitory storage medium may be any available medium that can be accessed by a general purpose or special purpose computer.

Also, any connection is properly termed a computer-readable medium. For example, if the software is transmitted from a website, server, cloud entity, cluster, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium.

Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

What is claimed is:

1. A method of operating a data system, the method comprising:
maintaining first and second virtualized instantiations in operation for at least a period of time during a migration of a process from a first domain associated with the first virtualized instantiation to a second domain associated with the second virtualized instantiation.

2. The method of claim 1, wherein the maintaining of the first and the second virtualized instantiations in operation for at least the period of time during the migration of the process comprises enabling at least one of detection or access of one or more functions, entities, or processes of the first domain by at least one entity of the second domain.

3. The method of claim 2, wherein the enabling of the at least one of detection or access of the one or more functions, entities, or processes of the first domain by the at least one entity of the second domain comprises enabling a destination physical host of the second domain to perform at least one of (i) detection or (ii) access of the first virtualized instantiation of the first domain.

4. The method of claim 1, wherein the maintaining of the first and the second virtualized instantiations in operation for at least the period of time during the migration of the process comprises enabling a physical host of the second domain to send or receive protocol transactions to the second virtualized instantiation, while simultaneously enabling a physical host of the first domain to perform one or more functions or process on the first virtualized instantiation.

5. The method of claim 4, wherein the enabling of the physical host of the second domain to send or receive protocol transactions to the second virtualized instantiation comprises enabling reading or writing registers.

6. The method of claim 4, wherein the enabling of the physical host of the second domain to send or receive protocol transactions to the second virtualized instantiation comprises enabling transmission or receipt of interrupts.

7. The method of claim 4, wherein the enabling of the physical host of the second domain to send or receive protocol transactions to the second virtualized instantiation comprises the physical host of the second domain accepting one or more upstream message types associated with one or more detectable side-effects of the second virtualized instantiation.

8. The method of claim 1, further comprising providing indication of a completed transaction.

9. The method of claim 8, wherein the providing of the indication of the completed transaction comprises causing the second virtualized instantiation to elect to pass through one or more transactions to a physical endpoint device to be completed thereat.

10. A computer readable apparatus having a non-transitory storage medium, the non-transitory storage medium comprising at least one computer program having a plurality of instructions, the plurality of instructions configured to, when executed on a digital processor apparatus, cause a computerized apparatus to:
block I/O traffic during a virtual machine (VM) migration process, the suspension comprising suspension of the I/O traffic from at least one of (i) a physical endpoint device function to one or more physical host functions, or (ii) the one or more physical host functions to the physical endpoint device function.

11. The computer readable apparatus of claim 10, wherein the blockage of the I/O traffic occurs inside an I/O traffic switch routing fabric, but neither the one or more physical host functions nor the physical host function, such that an awareness by the physical endpoint device functions and one or more physical host functions of the blockage only occurs based on an invocation of one or more flow control mechanisms of the I/O traffic switch routing fabric to prevent the physical endpoint device function from transmission of additional I/O traffic.

12. The computer readable apparatus of claim 10, wherein the plurality of instructions are further configured to, when executed on the digital processor apparatus, cause the computerized apparatus to:
unblock of the I/O traffic such that the I/O traffic is allowed to flow to at least one of (i) the physical endpoint device function, or (ii) the one or more physical host functions.

13. The computer readable apparatus of claim 10, wherein:
the one or more physical host functions comprise an originating host and a destination host, the originating host and the destination host having different identifications associated therewith; and
the blockage of the I/O traffic comprises use of traffic routing block/pause function that causes a flow control condition, wherein the flow control condition allows non-address-routed I/O transactions to drain from an I/O subsystem of the I/O fabric and complete before all remaining traffic is blocked using the traffic routing block/pause function, thereby ensuring that only address-routed traffic is present in the I/O subsystem when traffic is blocked using the traffic routing block/pause function.

14. The computer readable apparatus of claim 10, wherein:
the one or more physical host functions comprise an originating host and a destination host, the originating host and the destination host having a common identification associated therewith; and
the blockage of the I/O traffic comprises use of traffic routing block/pause function without regard for draining non-address-routed traffic before the blockage.

15. A system, comprising:
one or more data fabrics;
a source host, the source host having have one or more first virtualized domains or endpoints associated therewith; and
a destination host, the destination host having have one or more second virtualized domains or endpoints associated therewith;
wherein the one or more data fabrics comprise one or more pause points for traffic, the one or more pause points configured to implement a protocol whereby all types of traffic are blocked from arrival at a physical fabric device, and operations are completed within the one or more data fabrics by a virtual device instantiation (VDI) emulation implementation instead of the physical fabric device.

16. The system of claim 15, wherein the one or more data fabrics comprise a PCIe-compliant switch fabric.

17. The system of claim 15, wherein the source host comprise a server apparatus.

18. The system of claim 15, wherein supported types of operations of the VDI emulation are enabled to proceed at a respective one of the source host or destination host during a migration of a VM from one of the source host or the destination host to another one of the source host or the destination host.

19. The system of claim 15, wherein the one or more pause points enable at least the one or more first virtualized domains or endpoints and the one or more second virtualized domains or endpoints to simultaneously communicate with a physical fabric device, thereby allowing fewer traffic types to be completed solely by the VDI emulation that without the simultaneous communication.

20. The system of claim 15, wherein the physical fabric device is unaware of any blocking of the traffic.
